(19) United States
(12) Patent Application Publication
(10) Pub. No.: US 2015/0095980 A1
(43) Pub. Date: Apr. 2, 2015

(54) CONTROLLING SHARING OF CONTENT BETWEEN DATA PROCESSING DEVICES

(71) Applicant: NVIDIA Corporation, Santa Clara, CA (US)

(72) Inventor: Nikesh Balakumar, Trivandrum (IN)

(73) Assignee: NVIDIA Corporation, Santa Clara, CA (US)

(21) Appl. No.: 14/040,680

(22) Filed: Sep. 29, 2013

(51) Int. Cl. H04L 29/06

(52) U.S. Cl. CPC H04L 63/08; H04L 65/403
USPC 726/3

(57) ABSTRACT

A method includes executing an instance of a process on each of a data processing device and one or more another data processing device(s), and authenticating, registering or pairing the one or more another data processing device(s) with the data processing device through a Personal Area Network (PAN) associated with a user of the data processing device and/or a computer network based on an identifier. The method also includes sharing content generated and/or stored in the data processing device with the one or more another data processing device(s) through the PAN and/or the computer network, and providing, through the execution of the instance of the process, a capability to the user of the data processing device to control the sharing of the content with the one or more another data processing device(s). The control of the sharing includes restricting the sharing based on controlling a parameter of the sharing.

### FIELD OF TECHNOLOGY

This disclosure relates generally to data processing devices and, more particularly, to controlling sharing of content between data processing devices.

### BACKGROUND

A user of a data processing device (e.g., a mobile phone, a tablet) may utilize a computer network (e.g., the Internet) to share content (e.g., a video file, an image file, a text file) with another data processing device. The user may have to attach the content to an e-mail or upload the content to a server in order to enable another user of the another data processing device access said content. Uploading of the content or the e-mailing thereof may prove to be tedious to the user. The user may share the content with multiple other users across the computer network. In order to restrict access to the content uploaded to the server, for example, after a fixed duration of time, the user may have to manually log into the server.

### SUMMARY

Disclosed are a method, a device and/or a system of controlling sharing of content between data processing devices.

In one aspect, a method includes executing an instance of a process on each of a data processing device and one or more another data processing device(s), and authenticating, registering or pairing the one or more another data processing device(s) with the data processing device through a Personal Area Network (PAN) associated with a user of the data processing device and/or a computer network based on an identifier. The method also includes sharing, through the execution of the instance of the process, content generated and/or stored in the data processing device with the one or more another data processing device(s) through the PAN and/or the computer network. Further, the method includes providing, through the execution of the instance of the process, a capability to the user of the data processing device to control the sharing of the content with the one or more another data processing device(s). The control of the sharing includes restricting the sharing based on controlling a parameter of the sharing.

In another aspect, a non-transitory medium, readable through a data processing device and one or more another data processing device(s) and comprising instructions embodied therein that are executable through the data processing device and the one or more another data processing device(s), is disclosed. The non-transitory medium includes instructions to execute an instance of a process on each of the data processing device and the one or more another data processing device(s) and instructions to authenticate, register or pair the one or more another data processing device(s) with the data processing device through a PAN associated with a user of the data processing device and/or a computer network based on an identifier. The non-transitory medium also includes instructions to share, through the execution of the instance of the process, content generated and/or stored in the data processing device with one or more another data processing device(s) through the PAN and/or the computer network.

Further, the non-transitory medium includes instructions to provide, through the execution of the instance of the process, a capability to the user of the data processing device to control the sharing of the content with the one or more another data processing device(s). The control of the sharing includes restricting the sharing based on controlling a parameter of the sharing.

In yet another aspect, a data communication system includes a data processing device, and one or more another data processing device(s). Each of the data processing device and the one or more another data processing device(s) is configured to execute an instance of a process thereon. The one or more another data processing device(s) is configured to be authenticated, registered or paired with the data processing device through a PAN associated with a user of the data processing device and/or a computer network based on an identifier. The execution of the instance of the process is configured to enable sharing content generated and/or stored in the data processing device with the one or more another data processing device(s) through the PAN and/or the computer network.

Further, the execution of the instance of the process is configured to provide a capability to the user of the data processing device to control the sharing of the content with the one or more another data processing device(s). The control of the sharing includes restricting the sharing based on controlling a parameter of the sharing.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data communication system, according to one or more embodiments.

FIG. 2 is a schematic view of data processing devices of the data communication system of FIG. 1 with corresponding Near Field Communication (NFC) circuits.

FIG. 3 is a schematic view of transmission of a key from a data processing device to another data processing device of the data communication system of FIG. 1.

FIG. 4 is a schematic view of sharing of video content generated at the data processing device with the another data processing device of the data communication system of FIG. 1, according to one or more embodiments.

FIG. 5 is a process flow diagram detailing the operations involved in controlling sharing of content between data processing devices of the data communication system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of controlling sharing of content between data processing devices. Although the present embodiments have been described with reference to specific example embodiments, it will be evident that various modifications and changes may be made to these embodiments without departing from the broader spirit and scope of the various embodiments.

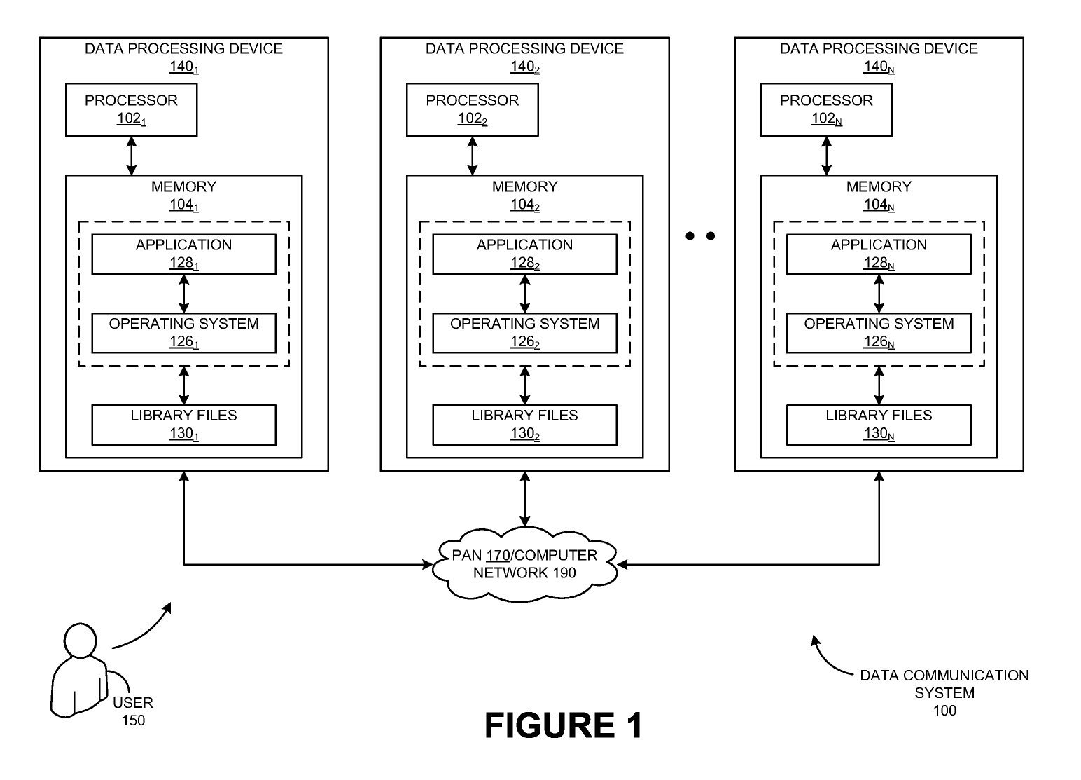

FIG. 1 shows a data communication system 100 configured to enable sharing of content generated on a data processing device 140₁ with one or more other data processing devices 140_{2-N} thereof, according to one or more embodiments. In one or more embodiments, each of data processing devices 140_{1-N} may be associated with an individual user. In one or more embodiments, each data processing device 140_{1-N} may be a mobile phone, a tablet, a laptop, a desktop, a smart media player, a notebook, a netbook or a smart television. Other forms of data processing devices 140_{1-N} are within the scope of the exemplary embodiments discussed herein.

In one or more embodiments, each data processing device 140_{1-N} may include a processor 102_{1-N} (e.g., a Central Processing Unit (CPU) and/or a Graphics Processing Unit (GPU)) communicatively coupled to a memory 104_{1-N} (e.g., a volatile memory and/or a non-volatile memory); memory 104_{1-N} may include storage locations configured to be addressable through processor 102_{1-N}. In one or more embodiments, each data processing device 140_{1-N} may execute an operating system 126_{1-N} thereon. In one or more embodiments, operating system 126₁ of data processing device 140₁ may be different from operating system 126₂ of another data processing device 140₂. In one or more other embodiments, two data processing devices (e.g., data processing device 140₁ and data processing device 140₂) may share a same operating system.

In one or more embodiments, each data processing device 140_{1-N} may execute an instance of an application 128_{1-N} thereon. FIG. 1 shows operating system 126_{1-N} and application 128_{1-N} as being stored in memory 104_{1-N}. In one or more embodiments, application 128_{1-N} may have a set of instructions associated with pairing/registering/authenticating one or more data processing device(s) 140_{2-N} with a data processing device 140₁, sharing content generated at data processing device 140₁ with the one or more data processing device(s) 140_{2-N} and/or controlling the sharing of content through data processing device 140₁. In one or more embodiments, for the aforementioned purpose, a non-transitory machine-readable medium including but not limited to a Compact Disc (CD), a Digital Video Disc (DVD) and a Blu-ray Disc® may include appropriate instructions embodied therein that can be executable through each data processing device 140_{1-N}; application 128_{1-N} may, therefore, be loaded onto each data processing device 140_{1-N}.

Alternately, the abovementioned set of instructions may be downloaded from, for example, the Internet and installed on each data processing device 140_{1-N}. In one or more embodiments, data processing device 140₁ may be coupled to another data processing device 140₂ through a network, examples of which include but are not limited to a short-range wired or wireless communication link such as a Personal Area Network (PAN) 170 (e.g., based on Wi-Fi Direct™, Bluetooth®, Near Field Communication (NFC)) and a computer network 190 such as the Internet, a Wide Area Network (WAN) or a Local Area Network (LAN). In one or more embodiments, in case of data processing device 140₁ and data processing device 140₂ having dissimilar operating systems, application 128₁ and/or application 128₂ may be packaged with appropriate library files 130₁₋₂ to enable compatibility of data communication therebetween; FIG. 1 shows both application 128₁ and application 128₂ being packaged with library files 130₁ and library files 130₂ respectively.

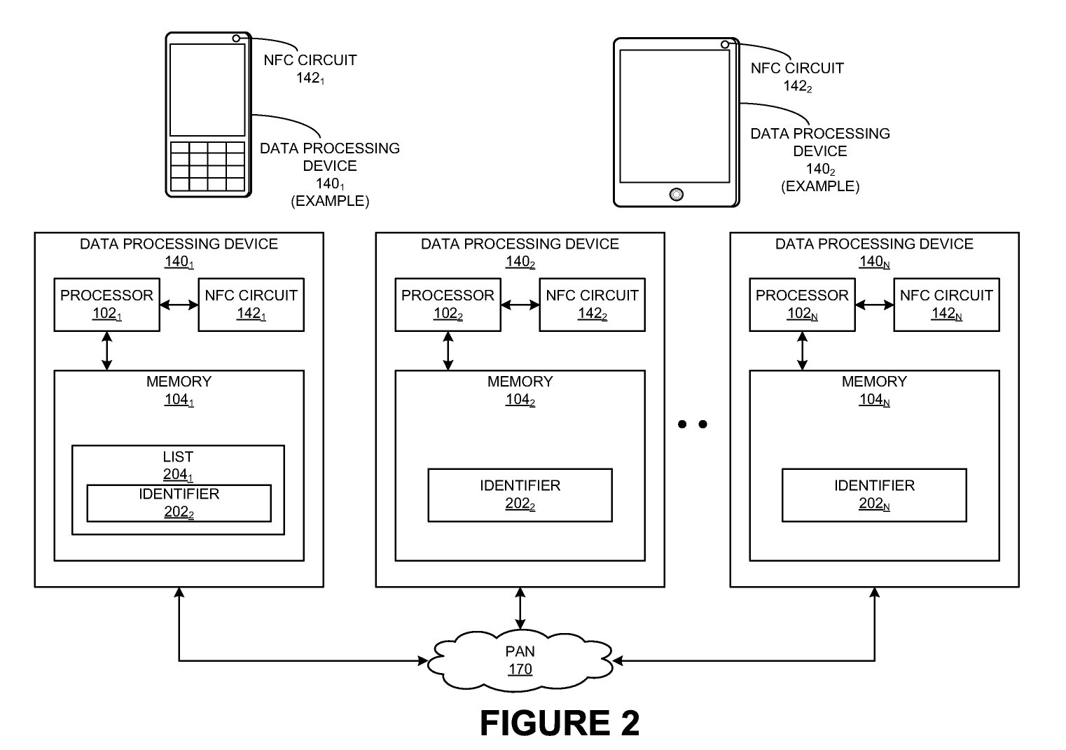

In one or more embodiments involving PAN 170, data processing device 140₂ may first be paired/registered with data processing device 140₁ prior to enabling the sharing of content and/or the control of said sharing. In one example embodiment, data processing device 140₂ may be paired with data processing device 140₁ through an NFC based communication link. For the aforementioned purpose, each data processing device 140_{1-N} may be NFC enabled. FIG. 2 shows data processing device 140₁ and data processing device 140₂ with corresponding NFC circuit 142₁ and NFC circuit 142₂ respectively.

As part of the pairing process, data processing device 140₁ and data processing device 140₂ may be brought in close proximity to one another; an identifier 202₂ of data processing device 140₂ may be read through NFC circuit 142₁ of data processing device 140₁; identifier 202₂ may be hard-coded into NFC circuit 142₂ of data processing device 140₂. Identifier 202₂ may then be stored in memory 104₁ of data processing device 140₁ in a list 204₁ of data processing devices 140_{2-N} configured to communicate with data processing device 140₁. One or more other data processing devices 140_{3-N} may also be paired with data processing device 140₁ in a similar manner to enable identifiers 202_{3-N} thereof being stored in list 204₁. Identifiers 202_{2-N} may enable identification of data processing devices 140_{2-N} when within range of communication of data processing device 140₁.

It should be noted that the communication link (e.g., NFC, Bluetooth®) utilized for the pairing/registration may be different from the communication link (e.g., Wi-Fi Direct™) utilized for sharing content and/or control of said content through data processing device 140₁. Alternately, the same communication link (e.g., Bluetooth®) may be employed for the registration/pairing, the sharing of content and/or the control of said content. Also, the abovementioned pairing process is merely for example purposes; other forms of registration are within the scope of the exemplary embodiments.

In one or more embodiments, through the registration of data processing devices 140_{2-N} with data processing device 140₁, user 150 may set up a personal network (e.g., PAN 170) to share content generated at data processing device 140₁ with one or more data processing device(s) 140_{2-N} and control the sharing thereof. In one or more other embodiments, the registration of data processing devices 140_{2-N} with data processing device 140₁ may be effected through a process of authentication through computer network 190. Here, data processing devices 140_{1-N} may leverage the Internet, for example, for registration. One or more data processing device(s) 140_{2-N} may, for example, access a Uniform Resource Locator (URL) through a web browser and register with data processing device 140₁. Application 128_{2-N} (e.g., executing on processor 102_{2-N}) may aid the process associated therewith. Data processing device 140₁ may transmit an encrypted key (e.g., a public key and/or a private key) to the one or more data processing devices 140_{2-N} to be used for gaining access (e.g., through computer network 190) to content generated at data processing device 140₁.

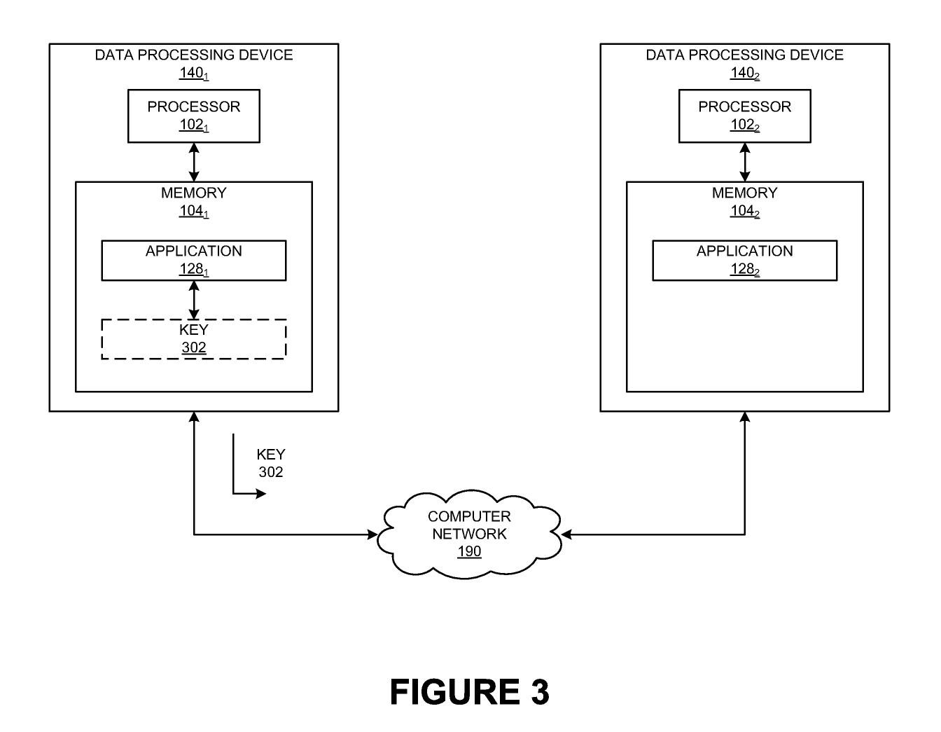

FIG. 3 shows the transmission (e.g., in an encrypted format) of a key 302 (e.g., stored in memory 104₁) from data processing device 140₁ to data processing device 140₂ through computer network 190. A user at data processing device 140₂ may enter the decrypted key 302 through a user interface (e.g., a web browser) to be registered/authenticated with data processing device 140₁. Thus, data processing device 140₂ may be paired with data processing device 140₁ to enable reception of content therefrom. It should be noted that in one or more embodiments, the pairing/registration may be accomplished through computer network 190 and the sharing of content/control thereof through PAN 170. In one or more embodiments, the execution of application 128₁ may enable data processing device 140₁ detect the presence of other data processing devices 140_{2-N} registered therewith based on identifiers 202_{2-N} in the case of communication through PAN 170 and the entering of keys (e.g., key 302) through data processing devices 140_{2-N} (e.g., data processing device 140₂) in the case of communication through computer network 190.

Other forms of authentication are also within the scope of the exemplary embodiments discussed herein. For example, a user at data processing device 140₂ may create an account with a website associated with data processing device 140₁. The user may log into the account to enable access to content generated at data processing device 140₁/use key 302 in conjunction therewith and/or obtain key 302 therethrough.

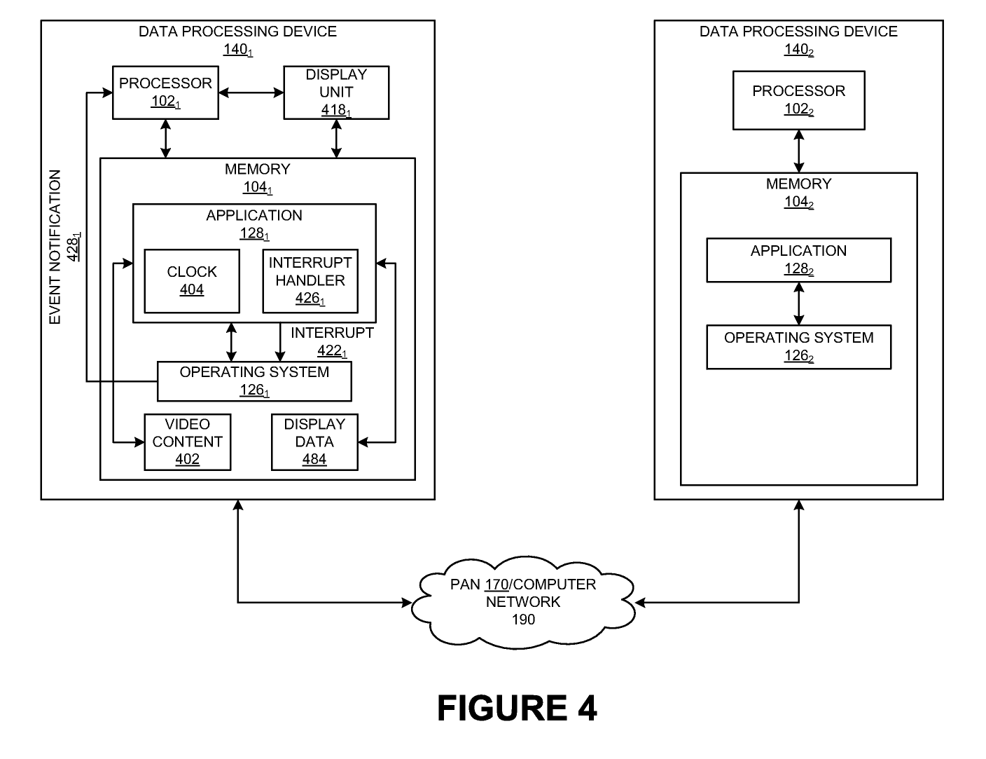

FIG. 4 shows video content 402 generated at data processing device 140₁. Video content 402 is shown as being stored in memory 104₁. It should be noted that the discussion here is solely related to sharing video content 402 with data processing device 140₂ merely for the sake of convenience and that sharing video content 402 with other data processing devices 140_{3-N} is also within the scope of the exemplary embodiments. In one or more embodiments, once data processing device 140₂ is paired/registered/authenticated (other forms are also possible) with data processing device 140₁, application 128₁ may cause transfer (e.g., through execution of instructions on processor 102₁) of video content 402 to data processing device 140₂ through PAN 170 or computer network 190. In one or more embodiments, the reception of video content 402 at data processing device 140₂ may be facilitated through the continued execution of application 128₂ (e.g., through processor 102₂).

In one or more other embodiments, through application 128₁, video content 402 may be tagged and stored in memory 104₁ to be accessed by data processing device 140₂ through PAN 170 or computer network 190. In one or more embodiments, application 128₁ executing on data processing device 140₁ may not only enable sharing video content 402 but also may enable control of the sharing. For example, data processing device 140₁ may only share video content 402 starting from a fixed time of a day. Here, application 128₁ may have a clock or a timer associated therewith, which activates the access to video content 402 through data processing device 140₂ or triggers transmission of video content 402 to data processing device 140₁ through PAN 170 or computer network 190 at the start of the fixed time of the day. FIG. 4 shows clock 404 as part of application 128₁. It is obvious that clock 404 (or, application 128₁) may also control duration of the sharing of video content 402; for example, video content 402 may be shared for two hours.

It should be noted that sharing of content is not limited to video content 402. For example, application 128₁ may enable sharing of text content, files (e.g., multimedia files such as audio files, text files, image files and/or video files, presentations, data sheets), folders (e.g., arranged through a file system implemented by operating system 126₁) including files or even display data (e.g., display data 484 shown as being stored in memory 104₁) rendered on a display unit 418₁ (e.g., a Liquid Crystal Display (LCD), a Cathode Ray Tube (CRT) monitor) associated with data processing device 140₁.

In the scenario of sharing video content 402 discussed with regard to FIG. 4, the detection of the time of the day corresponding to the sharing through clock 404 in conjunction with processor 102₁ may generate an interrupt 422₁ to operating system 126₁. Application 128₁ interfaced with operating system 126₁ or operating system 126₁ may include an interrupt handler 426₁ to handle said interrupt 422₁. FIG. 4 shows interrupt handler 426₁ as being implemented in application 128₁. Operating system 126₁ may then generate an event notification 428₁ that is detected through processor 102₁. Based on detection of event notification 428₁, processor 102₁ may be configured to initiate transfer of video content 402 to data processing device 140₂ through PAN 170 or computer network 190. Alternately, processor 102₁ may be configured to enable access to video content 402 thereat through data processing device 140₂ registered/paired/authenticated therewith.

In an example scenario, user 150 may be located in the United States and a relative thereof may be located in England. There may be a time difference between the two locations. Exemplary embodiments discussed herein may provide for a means to share video content 402 at a mutually convenient time or a time of convenience with respect to the relative. It should be noted that the content shared may be generated in real-time; alternately, the content may be a file stored in memory 104₁.

In another example scenario, an internal meeting may be broadcast to a set of employees of a company who are at remote locations. In yet another example scenario, a real-time performance on a gaming platform may be broadcast to a remote location. The utility of the exemplary embodiments is not merely limited to sharing of content. The sharing of content may enable a friend of user 150 at a remote location help debug issues with data processing device 140₁ based on transmission of display data 484. Further, the content shared may be combination of several forms of data; for example, video content 402 may have a voice commentary (example voice data) overlaid thereon.

In one or more embodiments, application 128₁ may enable data processing device 140₁ function as a server sharing content thereon; alternately, application 128₁ may also enable data processing device 140₂ function as a client device (analogous to data processing device 140₂ with respect to data processing device 140₁). Here, user 150 may be provided with the capability to access several channels, i.e., content from several data processing devices 140_{2-N}. For example, user 150 may search for a list of available channels through, for example, a web browser interface on data processing device 140₁ with the help of application 128₁. In one or more embodiments, application 128₁ may provide for a capability to switch between a server mode and a client device mode. In one or more other embodiments, data processing device 140₁ may operate in the server mode and the client device mode simultaneously. For example, user 150 may enable access to content (e.g., video content 402) on data processing device 140₁ through application 128₁ and also simultaneously access content on one or more other data processing devices 140_{2-N}.

In one or more embodiments, the abovementioned features may be provided on existing data processing devices 140_{1-N}. The add-on features may motivate mobile phone users to invest in high-end mobile phones. Further, the add-on features may increase information explosion by way of enabling access to content on a number of data processing devices 140_{1-N} through, for example, the Internet.

It should be noted that application 128_{1-N} may be a subset of a process (e.g., a daemon process) executing on data processing device 140_{1-N}. Each data processing device 140_{1-N} of data communication system 100 may be thought of as executing an instance of the process thereon. The control of the sharing of the content may be thought of as providing a capability to user 150 to restrict said sharing based on controlling a parameter (e.g., duration, date, time, a level of access such as access of high-definition (HD) quality video content 402, a frequency of access (e.g., 4 times, 20 times, 1 time), one or more specific data processing devices 140_{2-N} with which sharing is avoided) of the sharing.

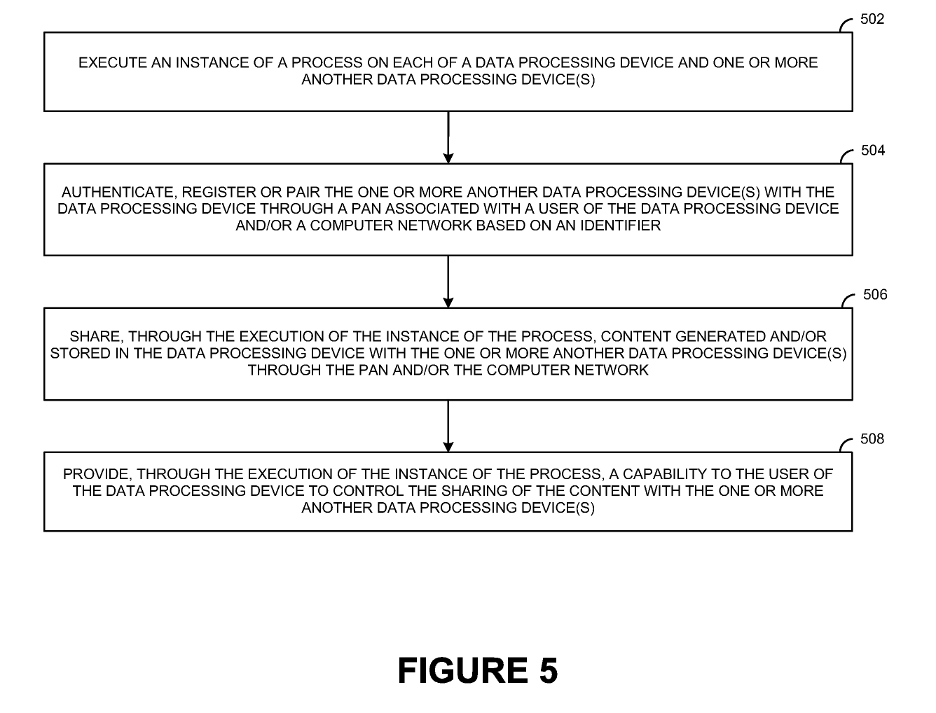

FIG. 5 shows a process flow diagram detailing the operations involved in controlling sharing of content between data processing devices 140_{1-N}, according to one or more embodiments. In one or more embodiments, operation 502 may involve executing an instance of a process (e.g., application 128_{1-N}) on each of data processing device 140₁ and one or more another data processing device(s) 140_{2-N}. In one or more embodiments, operation 504 may involve authenticating, registering or pairing the one or more another data processing device(s) 140_{2-N} with data processing device 140₁ through PAN 170 associated with user 150 and/or computer network 190 based on an identifier.

In one or more embodiments, operation 506 may involve sharing, through the execution of the instance of the process, content generated and/or stored in data processing device 140₁ with the one or more another data processing device(s) 140_{2-N} through PAN 170 and/or computer network 190. In one or more embodiments, operation 508 may then involve providing, through the execution of the instance of the process, a capability to user 150 to control the sharing of the content with the one or more another data processing device(s) 140_{2-N}. The control of the sharing includes restricting the sharing based on controlling a parameter of the sharing.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a data processing device 140_{1-N}). Accordingly, the specification and drawings are to be regarded in an illustrative rather than a restrictive sense.

What is claimed is:

1. A method comprising:
executing an instance of a process on each of a data processing device and at least one another data processing device;
one of: authenticating, registering and pairing the at least one another data processing device with the data processing device through at least one of: a Personal Area Network (PAN) associated with a user of the data processing device and a computer network based on an identifier;
sharing, through the execution of the instance of the process, content at least one of: generated and stored in the data processing device with the at least one another data processing device through the at least one of the PAN and the computer network; and
providing, through the execution of the instance of the process, a capability to the user of the data processing device to control the sharing of the content with the at least one another data processing device, the control of the sharing including restricting the sharing based on controlling a parameter of the sharing.

2. The method of claim 1, wherein the shared content is at least one of: a multimedia file, a presentation, a data sheet, a folder including at least one file and display data rendered on a display unit associated with the data processing device.

3. The method of claim 1, wherein the sharing of the content further comprises one of:
transmitting the content from the data processing device to the at least one another data processing device; and
enabling access to the content at the data processing device through the at least one another data processing device based on continued execution of the instance of the process.

4. The method of claim 3, further comprising tagging the content through the execution of the instance of the process to enable searching of the content through an interface associated with the at least one another data processing device to further enable access to the content through the at least one of the PAN and the computer network.

5. The method of claim 1, further comprising providing a capability to the data processing device to access another content from the at least one another data processing device in a client device mode of operation of the data processing device.

6. The method of claim 5, further comprising providing a capability to the data processing device to simultaneously share the content with the at least one another data processing device and access the another content from the at least one another data processing device in the client device mode of operation thereof.

7. The method of claim 1, wherein the parameter of the sharing is at least one of: a duration, a date, a time, a level of access, and a frequency of access.

8. A non-transitory medium, readable through a data processing device and at least one another data processing device and comprising instructions embodied therein that are executable through the data processing device and the at least one another data processing device, comprising:
instructions to execute an instance of a process on each of the data processing device and the at least one another data processing device;
instructions to one of: authenticate, register and pair the at least one another data processing device with the data processing device through at least one of: a PAN associated with a user of the data processing device and a computer network based on an identifier;
instructions to share, through the execution of the instance of the process, content at least one of: generated and stored in the data processing device with the at least one another data processing device through the at least one of the PAN and the computer network; and
instructions to provide, through the execution of the instance of the process, a capability to the user of the data processing device to control the sharing of the content with the at least one another data processing device, the control of the sharing including restricting the sharing based on controlling a parameter of the sharing.

9. The non-transitory medium of claim 8, comprising instructions compatible with the shared content being at least one of: a multimedia file, a presentation, a data sheet, a folder including at least one file and display data rendered on a display unit associated with the data processing device.

10. The non-transitory medium of claim 8, wherein the instructions to share the content further comprise one of:
instructions to transmit the content from the data processing device to the at least one another data processing device; and
instructions to enable access to the content at the data processing device through the at least one another data processing device based on continued execution of the instance of the process.

11. The non-transitory medium of claim 10, further comprising instructions to tag the content through the execution of the instance of the process to enable searching of the content through an interface associated with the at least one another data processing device to further enable access to the content through the at least one of the PAN and the computer network.

12. The non-transitory medium of claim 8, further comprising instructions to provide a capability to the data processing device to access another content from the at least one another data processing device in a client device mode of operation of the data processing device.

13. The non-transitory medium of claim 12, further comprising instructions to provide a capability to the data processing device to simultaneously share the content with the at least one another data processing device and access the another content from the at least one another data processing device in the client device mode of operation thereof.

14. The non-transitory medium of claim 8, comprising instructions compatible with the parameter of the sharing being at least one of: a duration, a date, a time, a level of access, and a frequency of access.

15. A data communication system comprising:
a data processing device; and
at least one another data processing device, each of the data processing device and the at least one another data processing device being configured to execute an instance of a process thereon,
wherein the at least one another data processing device is configured to be one of: authenticated, registered and paired with the data processing device through at least one of: a PAN associated with a user of the data processing device and a computer network based on an identifier,
wherein the execution of the instance of the process is configured to enable sharing content at least one of: generated and stored in the data processing device with the at least one another data processing device through the at least one of the PAN and the computer network, and
wherein the execution of the instance of the process is further configured to provide a capability to the user of the data processing device to control the sharing of the content with the at least one another data processing device, the control of the sharing including restricting the sharing based on controlling a parameter of the sharing.

16. The data communication system of claim 15, wherein at least one of:
the shared content is at least one of: a multimedia file, a presentation, a data sheet, a folder including at least one file and display data rendered on a display unit associated with the data processing device, and
the parameter of the sharing is at least one of: a duration, a date, a time, a level of access, and a frequency of access.

17. The data communication system of claim 15, wherein the sharing of the content is based on one of:
transmitting the content from the data processing device to the at least one another data processing device, and
enabling access to the content at the data processing device through the at least one another data processing device based on continued execution of the instance of the process.

18. The data communication system of claim 17, wherein the execution of the instance of the process is further configured to enable tagging the content to enable searching of the content through an interface associated with the at least one another data processing device to further enable access to the content through the at least one of the PAN and the computer network.

19. The data communication system of claim 15, wherein the execution of the instance of the process further provides a capability to the data processing device to access another content from the at least one another data processing device in a client device mode of operation of the data processing device.

20. The data communication system of claim 19, wherein the execution of the instance of the process provides a capability to the data processing device to simultaneously share the content with the at least one another data processing device and access the another content from the at least one another data processing device in the client device mode of operation thereof.
